(19) United States
(12) Patent Application Publication
(10) Pub. No.: US 2012/0088877 A1
(43) Pub. Date: Apr. 12, 2012

(54) RADIANT RESISTANT COATINGS, HEAT-SHIELDING METHODS, AND COATED PRODUCTS

(75) Inventors: Jerry Solov, Acworth, GA (US); Andrew Knapp, Acworth, GA (US)

(73) Assignee: GLOBALSHIELD, INC., Acworth, GA (US)

(21) Appl. No.: 13/271,034

(22) Filed: Oct. 11, 2011

Related U.S. Application Data
(60) Provisional application No. 61/391,161, filed on Oct. 8, 2010.

(51) Int. Cl. C08K 3/08; B02C 23/00

(52) U.S. Cl. 524/441; 241/25; 106/404

(57) ABSTRACT

A radiant resistant coating, heat-shielding methods, and coated products are provided. The coating can include an acrylic emulsion as a special carrier to enhance adhesion onto substrates, a defoamer to limit frothing during blending, a coalescent, polymerized aluminum pigment as a special heat rejecting element, an associative thickener to establish the proper viscosity, a PH additive as a stability enhancer, and water. This combined matrix provides a water-based, single entity radiant resistant coating with negligible VOC levels.

### CROSS-REFERENCE TO RELATED APPLICATIONS

This Application claims benefit under 35 USC §119(e) of U.S. Provisional Patent Application Ser. No. 61/391,161 filed 8 Oct. 2010, which is incorporated herein by reference as if fully set forth below in its entirety.

### BACKGROUND OF THE INVENTION

1. Field of the Invention

The present invention relates generally to coatings, and more specifically to improved radiant resistant coatings, heat-shielding methods, and coated products. The present invention relates to a heat-shielding method for preventing temperature buildup in closed spaces due to solar or other radiation and to a coated product, as fabricated by the heat-shielding method.

2. Description of the Related Art

Conventional roofing, for commercial and industrial buildings, usually includes a roof deck covered by a layer of insulation, followed by a water proof membrane and an exterior surface. Many commercial buildings have flat roofs, upon which, a commercial roofer commonly applies roll roofing in large single sheets. Asphalt is generally applied to the surface of the roof and the roll roofing is then applied on top of the asphalt. Alternatively, the roll roofing may have a layer of asphalt on one surface, which is heated, to apply the roll roofing to the roof.

There are many problems involving undesirable heat transfer, associated with conventional commercial roofing, because the roof absorbs solar energy from the sun. As a result, the roof becomes very hot during the day, causing higher interior temperatures and resulting in higher cooling costs. Typical roofing materials, such as mineral cap sheets, modified bitumen, asphalt, and gravel can absorb more than 70 percent of incident solar energy. Roofs typically having dark roofing materials, which tend to absorb more solar energy, may become as hot as 88° C. (190° F.) on a sunny day. Even lighter colored roofing materials (e.g. white or green) can become as hot as 79° C. (175° F.).

Certain insulation materials, and constructions, have been disclosed in the past to reduce cooling costs, including using a liquid medium located on a building structure, which can be cooled, such as a water jacketed enclosure. See U.S. Pat. Nos. 3,450,192; 3,563,305; 3,994,278; and 4,082,080. These disclose heating and cooling systems which utilize an energy source and a fluid medium for energy storage and transfer. The fluid medium is distributed over the roof of a building (e.g., in a network of piping) and includes mechanisms for regulating the temperature within the enclosed structure. In these types of systems, optimum cooling efficiency cannot be obtained and an external source is needed to obtain the cooling, resulting in additional costs.

Other methods for reducing cooling costs include applying a reflective coating onto the roof after the roof has been installed (retrofitted coatings), which can reduce the amount of solar energy that is absorbed by the roof. Reflective coatings can reflect much of the solar energy and can lead to reduced interior building temperatures and reduced cooling costs. For example, white roof coatings can reflect 70% to 80% of the sun's energy. Reflective coatings may include, inter alia, elastomeric coatings, aluminum fiber coatings, acrylic and polyurethane coating systems such as Mule-Hide acrylic and polyurethane coating systems, ceramic coatings, insulating paints such as those disclosed in U.S. Pat. No. 4,623,390, metal pigment paints, and metal pigment pastes such as those disclosed in U.S. Pat. No. 5,993,523. Aluminum foil laminations have also been used in an attempt to approach similar function and performance levels as coatings, but with inferior results and at greater expense. By making the roof less absorptive of solar energy, significant cooling-energy savings can be achieved.

The Environmental Protection Agency (EPA) and the Department of Energy (DOE) have organized the Energy Star® Roof Products Program, which is aimed at reducing cooling costs by using cool roofing products. The EPA and the DOE have recognized the energy-saving cost benefits of using reflective coatings on roofs and advocates their use. The Energy Star® label can be used on reflective roof products that meet the EPA's specifications for solar reflectance and reliability, to help consumers identify energy-efficient products.

While the cost benefits of reflective coated cool roofing are documented, the cost of installing cool roofing remains an issue. Conventional commercial roll roofing is often coarse and can absorb large amounts of the coatings that are applied to it. As a result, coarse roofing products require the use of significant amounts of reflective coating, which can be costly. In addition, conventional commercial roofing generally requires other components such as heavy glass mats, granules and finishes, which add to both material and installation costs.

Thus, there is a need for an easier, more cost efficient means to apply an energy-efficient reflective surface onto building elements, a need for improved radiant resistant coatings, and a need for improved coated products. It is to the provision of such radiant resistant coatings, heat-shielding methods, and coated products, that the present invention is primarily directed.

### BRIEF SUMMARY OF THE INVENTION

Briefly described, in a preferred form, the present invention comprises a unique coating for impeding the transfer of energy though structures, the coating being preferably a single component, water-borne, radiant resistant coating (RRC) that employs a reflective pigment extender. The present coating can comprise shaped metallic particles with a protective coating and can comprise negligible levels of volatile organic compounds (VOCs).

The present coating can be a single component fluid that uses water as its predominant vehicle. It can employ an acrylic resin binder to achieve adhesion to a variety of substrates and can adhere to most surfaces. The coating can comprise a unique, polymerized aluminum flake, the characteristics of which are different from conventional aluminum particles. The unique characteristics of the polymerized aluminum result in an augmented capacity to reject heat and lower thermal transfer across, and through, air, roofing, and other substances. In some embodiments, the coating can also comprise a coalescent, a stabilizer, and an associative thickener.

The coating has no known shelf life and preferably has an emissivity rating below 0.21. This translates to an emissivity rating that is at least 20-25% better than conventional radiant resistant coatings. In some embodiments, the coating can be applied to the outside surface of the roof decking, before the application of waterproofing, asphalt roll roofing felts, asphalt-based shingles, slates, tiles, metal panels or other roofing system components. In other embodiments, the coating can be applied to the underside of roof decking, for example, covering the decking and rafters. In a preferred embodiment, the present coating can be applied offsite to building elements, and then sent to the construction site (.e.g., for use in “prefab” buildings). On site, the coated lumber can be used to build, for example, the roof, walls, or other components of the structure.

Because the coating contains a pigment extender, it can significantly prevent roofing and other materials from transferring heat into the building by blocking a significant amount of the radiant energy that enters a building through, for example, the roof and/or walls. In addition, the radiant barrier can be coupled with insulation, solar-powered fans, and other features to substantially lower the load on, for example, building air conditioning systems. This can extend the life of the equipment, minimize noise pollution, and substantially lower electric bills, among other things.

Embodiments of the present invention can comprise a single component RRC that can be shipped and delivered in quantity. Because of its one-part configuration, as opposed to conventional two-part or catalyzed coatings, a builder or manufacturer can ship and use the coating in bulk using relatively simple mechanical means. In addition, due to the extended pot life, any unused coating can be stored for future use.

In some embodiments, the present invention is a heat-shielding system and method, wherein building elements, such as those used for constructing the basic building envelope (e.g., walls, roof deck, skin, etc.) can be provided with the radiant resistant coating pre-applied by the component manufacturer. In this embodiment, a structure can be considered an energy-efficient vessel, whose exterior, or “exo-skin,” can be considered a continuous radiant barrier. In other words, the structure can be viewed as a cube, with five or six sides of continuously coated surfaces using the system. In a residential dwelling, for example, the system can be applied to all wall boards that will be applied, for example and not limitation, to the exterior walls and ceiling. Optionally, the system can also be applied to the bottom floor sheathing panels.

The RRC can be used effectively for both cooling and heating. Of course, the same concept can be used for commercial and institutional structures (i.e., the same class of construction components are used for constructing the vast majority of residential and commercial structures built). Embodiments of the present invention can be, for example, factory applied coatings for the inside faces of all gypsum wallboard panels, enabling each structure to be made significantly more energy efficient.

Embodiments of the present invention can be effected using ceramic, metallic, or composite pigment, and pigment extenders, and can be mechanically pre-applied to an array of building components, in the factory, or field-applied on-site. In addition, field-applied touch-ups and repairs can be easily completed using, for example, a conventional commercial sprayer, roll, or brush to maintain the continuity of the coating and effect minor repairs.

These and other objects, features, and advantages of the present invention will become more apparent upon reading the following specification.

### BRIEF DESCRIPTION OF THE FIGURES

FIG. 1 depicts a reflective roof coating on a roofing system, in accordance with some embodiments of the present invention.

FIG. 2a depicts a reflective wall coating applied to the outside of a wall system, in accordance with some embodiments of the present invention.

FIG. 2b depicts a reflective wall coating applied to the inside of a wall system, in accordance with some embodiments of the present invention.

### DETAILED DESCRIPTION OF PREFERRED EMBODIMENTS

Although preferred embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the preferred embodiments, specific terminology will be resorted to for the sake of clarity.

It must also be noted that, as used in the specification, and the appended claims, the singular forms “a,” “an” and “the” include plural referents unless the context clearly dictates otherwise. Also, in describing the preferred embodiments, terminology will be resorted to for the sake of clarity. It is intended that each term contemplates its broadest meaning, as understood by those skilled in the art, and includes all technical equivalents, which operate in a similar manner, to accomplish a similar purpose.

Ranges may be expressed herein as from “about” or “approximately” one particular value and/or to “about” or “approximately” another particular value. When such a range is expressed, another embodiment includes from the one particular value and/or to the other particular value. By “comprising” or “containing” or “including” is meant that at least the named compound, element, particle, or method step is present in the composition or article or method but, does not exclude the presence of other compounds, materials, particles, method steps, even if the other such compounds, material, particles, method steps have the same function as what is named.

It is also to be understood that the mention of one or more method steps does not preclude the presence of additional method steps, or intervening method steps, between those steps expressly identified. Similarly, it is also to be understood that, the mention of one or more components in a device or system, does not preclude the presence of additional components or intervening components between those components expressly identified.

Conventional coatings are known, for example, Radiance, Heatbloc 75, Solec, and other RRCs, but these are generally two-component, solvent-based products. Because of the solvents, catalysts, hardeners, and other components involved, the conventional products are difficult to use and ship in bulk form and generally must be packaged in 4.5 gallon kits. In addition, because these products have a relatively short pot life, unused material from conventional products cannot be stored for future use once combined.

In contrast, embodiments of the present invention can comprise a single component RRC that can be shipped and delivered in quantity. To apply the coating, as opposed to the conventional choices, a builder or manufacturer can do so in bulk using relatively simple mechanical means (e.g., sprayers, brushes, and rollers). In addition, due to the extended pot life, any unused coating can be stored for future use.

Embodiments of the present invention can comprise a radiant resistant coating. The coating can comprise, for example, a single-component, waterborne acrylic emulsion with a uniquely shaped reflective pigment. The reflective pigment can comprise, for example and not limitation, aluminum, iron, steel, or plastic. In some embodiments, the reflective pigment can comprise, for example, a plastic flake coated in a reflective material (e.g., chromed plastic). In a preferred embodiment, the reflective pigment can substantially comprise aluminum.

The pigment can provide a heat rejecting component for the coating to significantly reduce, for example, solar heat gain into the structure and/or thermal heat loss from the structure. As discussed below, the pigment extender can comprise a silica polymerized, non-degrading, and uniquely shaped metallic particle preferably derived from aluminum ingots. To improve upon the brilliance of conventional standard or advanced “cornflake” shaped particles (i.e., those generally used in conventional solvent-based aluminum coatings) a proprietary process is used to form the aluminum particles to provide a consistent shape.

In some embodiments, a Vacuum Metalized Flake (VMF), which is a platelet-like aluminum pigment with an exceptionally high surface area and aspect ratio, can be used. The VMF technique creates flakes with a consistent, smooth, mirrored metallic effect with a highly reflective brilliant finish. Once formed, the flakes can be coated with one or more polymerized coatings to maintain long-term brilliance and isolate the flake from oxidation, chemical attack, or other degradation.

Conventional RRCs use common metal particles or powders in a standard or advanced cornflake form. Conventional aluminum flakes are produced by ball milling atomized aluminum powder into flakes. Unfortunately, the milled aluminum flakes have irregular surfaces, which cause diffraction and poor alignment in the coating. The resulting coating exhibits poor reflectivity and a relatively dull surface.

Embodiments of the present invention, however, relate to an improved flake manufacturing method that results in improved flake geometry. In some embodiments, the flakes can be milled to be a consistent lenticular, or silver dollar, shape. The flakes can be milled to provide a smooth surface and can be produced in, for example and not limitation, oval or round shapes. This improved technology can provide flakes with exceptionally bright surfaces.

Atomic Force Topography (“AFT”) can be used to measure flake topography and to evaluate the “hills and valleys,” measured in nanometers, on the surface of the metallic flakes. Ordinary milled flakes tend to cause increased light diffraction and, because of their irregular surfaces, tend to align poorly in a coating. This creates a finish with a darker appearance, with lower metallic travel, and with a mean flake roughness of between approximately 25 nm and 27 nm.

In contrast, depending on the application, embodiments of the present invention can enable the brilliance of the flakes, and the resulting coating to be varied, for example, by utilizing a lenticular (e.g., lens shaped) or ultra lenticular (e.g., bi-convex lens shaped) flake. Embodiments of the present invention can produce flakes with a brilliant, chrome-like quality with a mean roughness of between 10.1 nm (ultra-lenticular) and 17.4 nm (lenticular). In either case, the regularity of lenticular flakes, round or oval, are flatter and smoother than conventional milled flakes.

Embodiments of the present invention can further comprise vacuum metalized flakes (VMFs). VMFs can be produced by heating aluminum to approximately 2700 F, the point at which solid aluminum turns to gas in a highly evacuated chamber. As the gas cools, it can be deposited onto a very smooth plastic surface to form a film. This metallic veneer is highly reflective (e.g., mirror-like) and quite thin, having a surface roughness—as measured using AFT—between approximately 3.6 and 3.8 nm. Metal flakes can then be produced from the deposit by removing the aluminum veneer from the plastic surface and breaking the metal film into small flakes using, for example and not limitation, vibration or crushing. In the configuration, the flakes bear the characteristics of vapor deposited metal, e.g., extremely smooth surfaces, brilliant reflectivity, and very thin cross-sections.

Embodiments of the present invention, however, relate to using the aforementioned aluminum flakes in a waterborne solution. Unfortunately, aluminum oxidizes in contact with water and generates hydrogen gas. It is possible, stoichiometrically, for one gram of aluminum to generate more than 1000 ml of hydrogen. This reaction can cause, for example, drums of paint to swell and/or explode posing obvious safety and storage issues. In addition, the reaction with water (i.e., oxidation) affects the hiding capacity, color, and orientation of the aluminum flakes in the coating. Aluminum Oxide, for example, generally has a dull white or light gray appearance with low reflectivity. It is desirable, and possibly necessary, to provide an oxidation inhibitor for water-based aluminum dispersions.

Embodiments of the present invention, therefore, can further comprise a system and method for providing specially formed aluminum flakes with a polymer coating. To inhibit the oxidation of the aluminum flakes, each flake can be coated in, for example and not limitation, glass, plastic, or other water-resistant clear materials. In a preferred embodiment, each flake can be coated in an inhibitor based upon a silica encapsulation. This polymerization process can result in a surface treatment that is very effective in water-borne coating systems. The process can be heavy metal free and can provide gassing stability and optical properties comparable to, for example, chromate passivated pigment types. This method can provide an aluminum pigment with high brilliance and little or no observable degradation under adverse conditions (e.g., high shear stress).

Embodiments of the present invention can also prevent deformation of the aluminum flakes during manufacture and use. Aluminum flakes are typically malleable and easily bent, broken, or deformed, particularly under shearing conditions. Long-term circulation, for example, during the stirring or blending process, can quickly change the appearance of the metallic coating due to degradation of the aluminum flakes. In addition to preventing oxidation, therefore, the silica coating on each flake can also enable the flake to resist degradation and can improve long term quality and brilliance during, for example, mixing and application. In addition, the elimination of toxic heavy metals in paints and coatings—like those conventionally used in the passivation processing of aluminum for use in aqueous paint and coatings—renders embodiments of the present invention safer to apply and more environmentally friendly. This improves the environmental and occupation safety of the product and lowers the associated risks and costs.

Unlike embodiments of the present invention, conventional RRCs utilize a plurality of components, are usually solvent bearing and, as a result, have high levels of volatile organic compounds (“VOCs”) and relatively high emissivity ratings. Furthermore, the chemical reaction required to activate multiple component (e.g., two-part) products, can produce flammable gas (e.g., hydrogen gas) and must be used in their entirety or disposed of when the “pot life” is reached. Consequently, plural component RRCs can be more costly to apply.

In contrast, embodiments of the present invention can comprise a single component coating that can be factory blended and has no known shelf life. This can provide a product that is indefinitely storable and, because it is factory blended, rather than being mixed on site, has improved quality and consistency. Further, embodiments of the present invention contain negligible VOCs and can provide an emissivity rating below approximately 0.21. In a preferred embodiment, the emissivity rating is between approximately 0.18-0.20, depending upon the substrate to which it is applied.

As an RRC, embodiments of the present invention can comprise a specialized coating that impedes the transfer of radiant energy into, and out of, a structure. The coating can be applied to building components such as wall board, sheathing, insulation, steel, roof decks, sheet metal, concrete, and wood, among other things. Rejection of heat affects rates of energy used to power cooling systems or heating systems. In cold climates, therefore, the coating can prevent energy (e.g., heating) from escaping from the structure, while in warm climates the coating can prevent heat (e.g., solar gain) from entering the structure. The coating can be applied using a variety of conventional means including, but not limited to, brushing, mopping, or spraying. In a preferred embodiment, the coating can be a fluid-applied material compatible for spray application.

In an exemplary embodiment, the coating can include an acrylic emulsion comprising one or more defoamers (e.g. Foammaster® NXZ), colescents (e.g., butyl cellosolve), and a heat reflective pigment. In a preferred embodiment, the coating can comprise glycol ether as a coalescent and a polymerized, uniquely shaped aluminum pigment as the heat reflecting element. In other embodiments, the coating can also include an associative thickener (e.g. Plasticryl AST-35) to establish the proper viscosity, a PH additive (e.g., ammonia), a stability enhancer (e.g. Fungitrol® 440S), and water.

Embodiments of the present invention can also comprise a method for applying a radiant resistant coating. Field-applied coatings tend to have non-uniform thickness and consistency, among other things, and, therefore, can lack efficiency and economy. In contrast, embodiments of the present invention can comprise a factory applied coating and can produce uniformity of coating thickness. This can enable the coating to be applied, for example, at the minimum effective thickness to maximize effectiveness while minimizing cost and weight. The coating can be applied between approximately 0.002″ and 0.012″, depending on the substrate. In some embodiments, the coating can be applied between approximately 0.005″-0.007″, and is preferably applied at approximately 0.006″ (6 mils). Thicknesses in this range can be fully functional, while also economical. Thicker application rates can be used, for example, on particularly irregular surfaces, but do not tend to improve reflective performance.

The factory pre-application of the radiant barrier can be used, for example, on building components that form part of the building envelope (e.g., floors, walls, roof panels, etc.). Factory application can occur as a step in the fabrication and finishing of, for example and not limitation, plywood, gypsum wall board, oriented strand board, steel, aluminum, and metal and wood roof decking. Application of the radiant resistant coating during the fabrication process can be accomplished by, for example and not limitation, spray, bath, dip, roll, drip, atmospheric atomization, broadcast, lamination, self-adhering thin film, embossing, stamping, material enmeshment, and brush.

In a preferred embodiment, the coating can be applied by a mechanical spray to provide a uniform and evenly distributed layer. The spray method is also desirable as it is easy to interrupt and resume (i.e., for maintenance or resupply operations). Interrupting the application, and starting up the application, within the same production line, also enables the original equipment manufacturer (“OEM”) to apply, or skip, building components at will. This enables a single manufacturing line to produce prefabricated pieces and panels with or without the coating with little or no interruption.

The coating can provide an OEM energy efficiency coating process that rejects and expels heat. In other words, it impedes radiant heat movement into and out of, the interiors of occupied spaces. The process can be an integral part of fulfilling the current need to provide energy conserving (or, “Green”) construction. The system and process can provide enhanced energy effectiveness and can enable OEMs to easily add energy efficient variants to their existing product offerings.

As discussed, aluminum foil laminations have been used in an attempt to approach similar function and performance levels as coatings, but represent greater installation and material expense, among other things. The present process provides installation flexibility in that it can be applied to the entire structure or to only small portions thereof (i.e., it can be applied in significantly smaller quantities than the convention foil method). In addition, the polymerized aluminum pigment is significantly more efficient than other conventional radiant resistant coating application methods, achieving superior emissivity results, while being more cost effective. This results in a greater return on investment than other factory or field-applied options.

Embodiments of the present invention, therefore can provide OEM processes that enable variant product(s) (i.e., products with and without the coating) to be produced for the lowest practical cost, making it universally attractive to use. In this setting, the efficiency of the application of the radiant resistant coating can be maximized by closely controlling the dry film thickness of the product during application. This can be accomplished, for example, by periodically checking the wet mil thickness using a wet mil gauge, or other suitable equipment. As with most coatings, too much material is wasteful, while too little material may not achieve the desired emissivity.

Embodiments of the present invention can also comprise a field applied coating to improve building emissivity. The system can be field applied using suitable equipment for use on existing buildings where factory application is not possible or practical. The system can be, for example, sprayed, rolled, or otherwise applied to accessible interior and/or exterior panels and can provide an economical retrofit for older, less efficient building technologies.

In a preferred embodiment, therefore, embodiments of the present invention can comprise a reflective roof coating. In use, conventional aluminum pigmented roof coatings tend to be solvent-based and, due to exposure of the aluminum to the elements, tend to become dull within a few years, thereby losing the desired reflectivity. In addition, due to their inferior adhesion, conventional aluminum roof coatings can detach and wash-off of substrates within approximately 2-5 years. As a result, conventional coatings require periodic re-coating, which represents a significant maintenance expense to the building owner. In addition, conventional solvent based aluminum roof coatings are typically applied at rates of between 75 and 150 square feet per gallon. In contrast, embodiments of the present invention can be applied at applied at rates of between 250 and 350 square feet per gallon. This can result in a significant material and labor savings when compared to conventional RRCs.

In addition, when necessary, re-coating a surface previously coated with embodiments of the present invention can be accomplished at reduced cost when compared to conventional coatings. Thus, in addition to a comparatively long initial service life, the coating can be easily and efficiently recoated. Only simple washing of the surface, using a water solvent, for example is required for complete re-coating preparation. In contrast, conventional coatings may require a primer coat, scraping (e.g., to remove loose, oxidized material), or other preparatory steps before re-coating.

Conventional aluminum roof coatings generally use asphalt dissolved in solvent, as the fluid vehicle. Over time, oils in the asphalt vehicle evaporate causing the coating to become dry and rigid, resisting the forces of expansion and contraction, producing cracking, detachment, and delamination from the substrate. In contrast, the coating described herein is elastomeric in nature enabling it to endure surface movement by, for example, temperature-induced expansion and contraction. This enables the coating to move with the substrate without cracking, which improves service life and reduces both materials and labor when recoating.

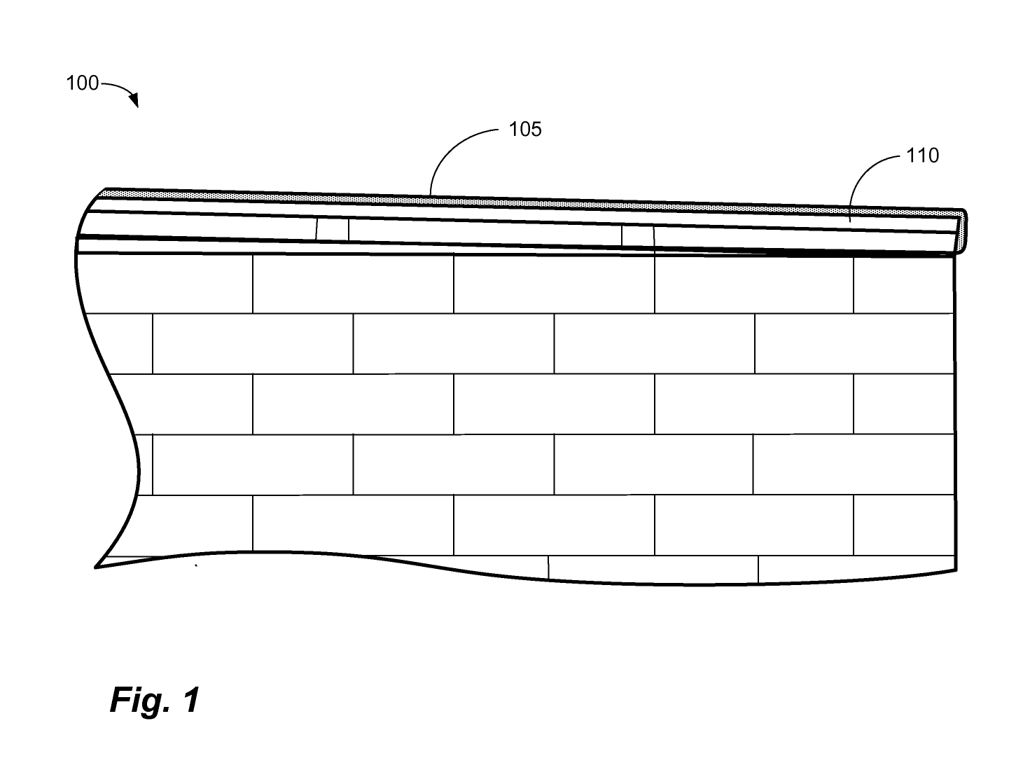

In some embodiments, as shown in FIG. 1, the water-based reflective aluminum roof coating (“RARC”) 105 can be applied, for example, to the outer surface 110 of low-slope or steep slope residential, commercial, industrial, and/or institutional roof systems 100 and can provide an enduring, brilliant reflective coating. Due to the polymer encapsulation of the metallic pigment, embodiments of the present invention maintain their brilliance and initial Solar Reflectance Index value (SRI). In addition, the resins used provide secure adhesion of the RARC 105 to roof surfaces 110 and degradation over time is significantly reduced, thus reducing recoating frequency. As a result, the system provides an economical reflective and protective roof coating.

In some embodiments, as shown in FIG. 1, the water-based reflective aluminum roof coating (“RARC”) 105 can be applied, for example, to the outer surface 110 of low-slope or steep slope commercial, industrial, or institutional roof system 100 and can provide a brilliant reflective coating. Due to the polymer encapsulation of the metallic pigment, embodiment of the present invention maintains its brilliance and initial Solar Reflectance Index value (SRI). In addition, the aliphatic elastomer, acrylic resin binder, can provide secure adhesion to the vast majority of adequately cleaned and prepared surfaces. In some embodiments, an additional primer coat of acrylic roof primer can be used for enhanced adhesion.

In addition to improved adhesion, the aliphatic acrylic resin can also provide enhanced protection from ultra-violet light degradation. This can provide a reflective roof coating with similar or better performance than conventional white acrylic roof coatings, with a service life of up to ten years or longer. This can reduce recoating and maintenance and provides an economical reflective and protective roof coating.

The systems' reflective capacity, when used as a roof coating 105, also maintains roofing components 100 at lower temperatures in hot climates, which can extend the service life of the roof 100 beyond the predicted life span. Extended roof life translates into fewer repairs and lower maintenance costs for home and building owners. The reflective rate, at the preferred dry mil thickness, is substantially greater than conventional aluminum roof coatings. In addition, conventional aluminum roof coatings, applied to smooth roof surfaces, depending upon aluminum paste content and fillers used, are generally applied at rates of between 75-150 square feet per gallon, per coat. In addition, many conventional aluminum roof coatings require two coats in order to achieve published service lives and SRIs. In contrast, embodiments of the present invention on smooth roof surfaces can coat up to 350 square feet per gallon and can require only a single application. This represents a significant reduction in material and labor costs over conventional systems.

Embodiments of the present invention can comprise a reflective aluminum roof coating 105. In a preferred embodiment, the roof coating 105 can comprise an acrylic emulsion as a special carrier to enhance adhesion onto substrates, a defoamer to limit frothing during blending, glycol ether as a coalescent, polymerized, uniquely shaped aluminum pigment as a special heat reflecting element, an associative thickener, to establish the proper viscosity, a PH additive, as a stability enhancer, and water. This combined matrix provides a water-based, single entity reflective aluminum roof coating (RARC) 105 with negligible VOC levels.

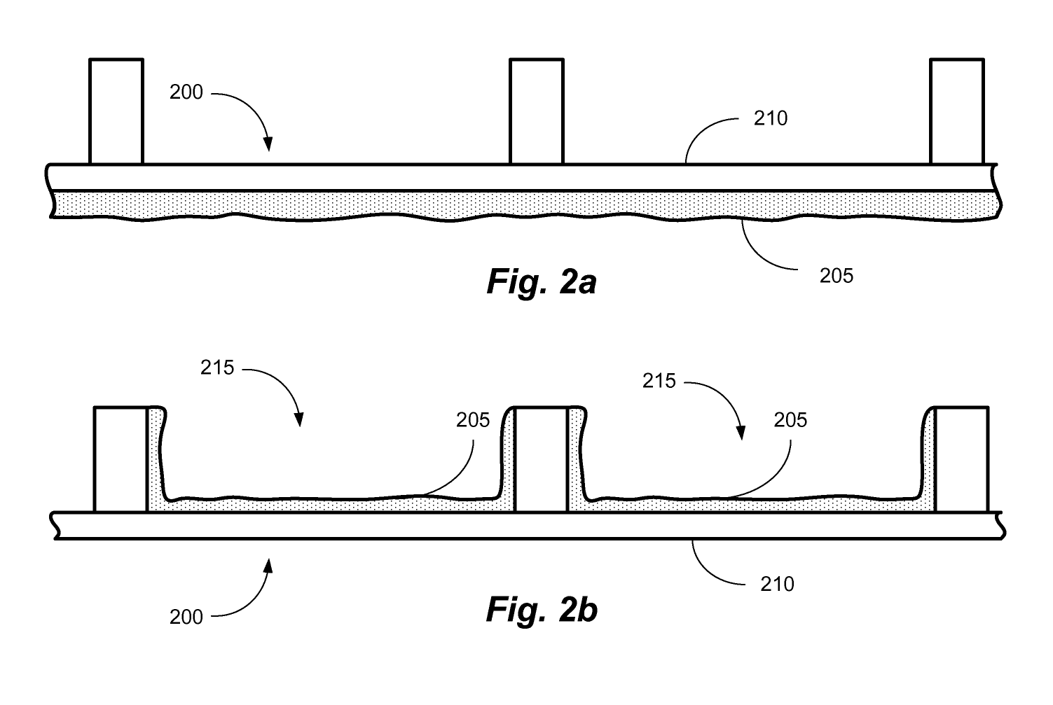

In other embodiments, as shown in FIGS. 2a and 2b, the coating 205 can be applied to the inside (FIG. 2b) or the outside (FIG. 2a) of interior or exterior wall systems 200. In some embodiments, the coating 205 can be applied to the outside of wall sheathing 210 to provide a heat reflective coating, for example, to the outside of the wall system 200. The coating 205 can be applied, for example, to the outside of wall sheathing 210 prior to the application of the finish siding. This can provide a heat reflective, emissive coating 205 to the exterior surfaces of the structure to reduce heat gain in warm climates and heat loss in colder climates.

In other embodiments, the coating 205 can be applied to the inside of wall sheathing 210 to provide a heat reflective, emissive coating, for example, to the inside of the wall system 200. The coating 205 can be applied, for example, to the inside of wall sheathing 210 in the stud cavity 215 prior to the installation of additional insulation and/or interior wallboard. This can provide a heat reflective, emissive coating 205 to the interior surfaces of the structure to reduce heat gain in warm climates and heat loss in colder climates.

While several possible embodiments are disclosed above, embodiments of the present invention are not so limited. For instance, while several possible methods and configurations for providing a reflective coating on, for example, building materials have been provided, other suitable configurations and combinations could be selected without departing from the spirit of embodiments of the invention. In addition, the location and configuration used for various features of embodiments of the present invention can be varied according to a particular building style or construction, different climates, different building materials, and/or space or power constraints. Such changes are intended to be embraced within the scope of the invention.

The specific configurations, choice of materials, and the size and shape of various elements can be varied according to particular design specifications or constraints requiring a device, system, or method constructed according to the principles of the invention. Such changes are intended to be embraced within the scope of the invention. The presently disclosed embodiments, therefore, are considered in all respects to be illustrative and not restrictive. The scope of the invention is indicated by the appended claims, rather than the foregoing description, and all changes that come within the meaning and range of equivalents thereof are intended to be embraced therein.

What is claimed is:

1. A method of manufacturing a highly reflective particle for use in a low-emissivity, highly reflective coating comprising:
melting a metal under a vacuum to create a metallic vapor;
solidifying the metallic vapor on a form to create a metallic veneer thereon;
removing the metallic veneer from the form; and
disintegrating the metallic veneer to form a plurality of reflective flakes.

2. The method of claim 1, wherein the plurality of reflective flakes comprise aluminum.

3. The method of claim 1, wherein the plurality of metallic flakes comprises an oval or round cross-section.

4. The method of claim 1, wherein the form comprises a smooth plastic surface.

5. The method of claim 1, further comprising:
coating each of the plurality of reflective flakes with a clear coating.

6. The method of claim 5, wherein the clear coating is a polymer.

7. The method of claim 5, wherein the clear coating is silica.

8. A method of manufacturing a low-emissivity, highly reflective coating comprising:
forming a plurality of metallic flakes with a consistent cross-section;
coating the plurality of metallic flakes with a clear protectant to maintain the reflectivity and stability thereof; and
combining the plurality of metallic flakes with an acrylic emulsion to form a waterborne, single-component, emissive or reflective coating.

9. The method of manufacture of claim 8, wherein the plurality of metallic flakes are formed by:
melting metal ingot into a fluid state; and
atomizing the melted metal to form a plurality of lenticular flakes with a consistent cross-section.

10. The method of manufacture of claim 8, wherein the plurality of metallic flakes are formed by:
heating metal to a gaseous state inside a vessel under a vacuum;
depositing the gaseous metal onto a smooth surface to form a metalized foil; and
converting the metalized foil into smooth, highly reflective flakes using vibration.

11. The method of manufacture of claim 10, wherein the smooth surface is a smooth, plastic lens.

12. The method of manufacture of claim 10, wherein the metal is aluminum.

13. The method of manufacture of claim 8, further comprising:
combining the waterborne, single-component reflective coating with one or more of a defoamer, a coalescent, a thickener, and a PH adjuster.

14. A low-emissivity, highly reflective coating comprising:
a plurality of metallic flakes with a consistent cross-section and coated in a protective coating to maintain the reflectivity and stability thereof; and
an acrylic emulsion;
wherein the plurality of metal flakes and the acrylic emulsion form a waterborne, single-component, reflective or emissive coating; and
wherein the metal flakes are formed by:
heating metal to a gaseous state inside a vessel under a vacuum;
depositing the gaseous metal onto a smooth surface to form a metalized foil; and
converting the metalized foil into smooth, highly reflective flakes.

15. The low-emissivity, highly reflective coating of claim 14, wherein the plurality of metal flakes comprise aluminum.

16. The low-emissivity, highly reflective coating of claim 14, wherein the metalized foil is converted into smooth, highly reflective flakes using vibration.

17. The low-emissivity, highly reflective coating of claim 14, wherein the metalized foil is crushed to convert the metalized foil into smooth, highly reflective flakes.

18. The low-emissivity, highly reflective coating of claim 14, wherein the metalized foil is frozen and then shattered to convert the metalized foil into smooth, highly reflective flakes.
